(19) United States
(12) Patent Application Publication
(10) Pub. No.: US 2005/0055353 A1
(43) Pub. Date: Mar. 10, 2005

(54) Acquiring, managing, distributing, and presenting contextual data relating to a known postion for location-based services to and between users

(76) Inventors: Peter Samuel Marx, Los Angeles, CA (US); Ahti Alan Hujanen, Oakdale, MN (US); Mayer Alan Brenner, Los Angeles, CA (US)

Correspondence Address: HOGAN & HARTSON L.L.P., 500 S. GRAND AVENUE, SUITE 1900, LOS ANGELES, CA, 90071-2611, US

(21) Appl. No.: 10/765,410

(22) Filed: Jan. 27, 2004

Related U.S. Application Data
(60) Provisional application No. 60/444,295, filed on Jan. 30, 2003.

(51) Int. Cl. G06F 17/30

(52) U.S. Cl. 707/10

(57) ABSTRACT

The present invention discloses a method and apparatus for supporting the acquisition, management, distribution, and presentation of contextual information related to positioning information sharing location services to, from, and between users. An infrastructure-based system connects users to location-associated data entries that give historical, contextual, and informational data for specific locations, as well as providing the ability for users to enter their own personal data. Access levels to the data can be achieved through a number of methods.

### CROSS-REFERENCE TO RELATED APPLICATIONS

This application claims priority under 35 U.S.C. § 119(e) of U.S. Provisional Patent Application Ser. No. 60/444,295, filed Jan. 30, 2003, entitled “ACQUIRING, MANAGING, DISTRIBUTING, AND PRESENTING CONTEXTUAL DATA RELATED TO A KNOWN POSITION FOR LOCATION-BASED SERVICES TO AND BETWEEN USERS,” by Peter Samuel Marx, et al., which application is incorporated by reference herein in its entirety.

### BACKGROUND OF THE INVENTION

1. Field of the Invention

The present invention relates in general to location services, and in particular to sharing location services between acquiring, managing, distributing, and presenting contextual data relating to a known position from and to users, and sharing location services between users.

2. Description of the Related Art

Currently, Global Positioning System (GPS) devices and other position-determining systems (e.g. LORAN, inertial guidance systems, and printed or displayed maps) report position in longitude, latitude, and altitude, or provide a position on a map for users to find their way. For example, a typical location services system can report a location of Latitude 44° 95′ 325″, Longitude 93° 64′ 632″ at an altitude of 905 feet above sea level. Range-finding systems such as very-high-frequency omnidirectional radio (VOR), radio triangulation, laser-range-finders (LRF), radar, sonar, and printed or displayed maps already can provide a distance and bearing to a known location (such as a radio transmitter or an airport). (Printed maps actually provide both absolute positions in the form of latitude, longitude, and altitude as well as indirect positions through reference to a known street, city, etc.) Some other typical mobile GPS systems incorporating GPS and similar devices can report information about the surrounding area, such as the direction and distance to the nearest service station or restaurant.

While such knowing one's position on the Earth is often quite useful at times, the information without contextual guidance, such as historical or other related meta-information, is often of little interest in itself, and does not have a particular impact for the user. Further, multiple locations can be linked together to create a virtual tour guide for contextual guidance through disparate physical locations.

As an example, the location of an automobile for sale is important to the potential buyer. However, knowing the history of the particular car that is being offered, e.g., that it is the Ford Mustang that was driven by Steve McQueen in the movie “Bullitt,” provides additional contextual information to the location services system user that may be more meaningful to the user. Allowing the system access to share the stories (contextual information) behind a given location or given object provides a further refinement on the promise behind the system's capabilities.

By way of another example, the contextual information of a given location is often the basis for tourism and travel. Europe is a popular tourist destination for a number of reasons and offers an opportunity to people to explore its culture and history (contextual information). The system described herein provides access to contextual information associated with any location (or planned location) specified by the user.

It can be seen, then, that there is a need in the art for components and a system that report supports the acquisition, management, distribution, and presentation of contextual information related to positioning information along with contextual guidance. It can also be seen that there is a need for a system that can share historical, descriptive, and personal items of interest between users.

### SUMMARY OF THE INVENTION

To minimize the limitations in the prior art, and to minimize other limitations that will become apparent upon reading and understanding the present specification, the present invention discloses a method and apparatus for sharing location services data between users.

An apparatus in accordance with the present invention comprises a computer-based infrastructure, including at least one database for storing information on at least one location, a context manager, coupled to the database, for indexing and sorting the information stored in the database, a contribution engine, coupled to the database, for entering, storing, managing, and retrieving additional information in the database, a locator, coupled to the contribution engine and the database, for converting a plurality of references to a specific location to a common location designation, and a location browser, coupled to the database, for retrieving and reviewing information in the database; and at least one client, which communicates with the infrastructure, for entering, editing, and retrieving information from the database.

It is an object of the present invention to provide components and a system that report positioning information along with contextual guidance. It is another object of the present invention to provide a system that can share historical, descriptive, and personal items of interest between users.

### BRIEF DESCRIPTION OF THE DRAWINGS

Referring now to the drawings in which like reference numbers represent corresponding parts throughout:

FIGS. 1A and 1B illustrates a system overview of the present invention;

FIG. 2 illustrates a first flow diagram in accordance with the present invention;

FIG. 3 illustrates typical platforms compatible or used with the present invention;

FIG. 4 illustrates a preferred embodiment of the channels and user interface of the present invention; and

FIG. 5 is a flowchart of the steps used in practicing the invention.

### DETAILED DESCRIPTION OF THE DRAWINGS

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

The present invention comprises an open system to provide contextual information about a location. Normal systems provide a description of the location itself - for example, latitude and longitude, an address, a set of directions, and the like. The present invention provides information about events and things at the location. For example, the present invention comprises a system that relates stories of what happened at any location in the world; who was there, and when and what they were doing. We encounter this situation all the time, of course, but there has been little done to make it systematic. Everyone knows that the Civil War took place at locations such as Antietem, Gettysburg, and the like. Similarly, Lewis and Clark traveled across the country along a well-defined path.

Typically one uses a map to find the location in which a story took place, e.g., one goes to the path across which Lewis and Clark traveled, and you read a book or some other reference material to give you some context, but not about the place you are visiting. The present invention adds to the experience by providing additional information about a given location; the information about a given location is accessed by correlating the information to the location using GPS coordinates. The present invention changes the metaphor: it tells the story of the location one is at or of the location one is interested in. Other examples include the story of the people who lived in your house before you did, who went to your school, or of what took place along the route of your school bus. Quite simply, one can use the present invention to discover the stories or other contextual information around and under you. Using a GPS-enabled device, a web-browser, a cell phone, or just a regular phone, you can find out what took place wherever you want.

The present invention also allows a user to contribute stories about a given location. For example, people that are interested in history can relate historical facts and essays to given locations; the Boston Massacre, Paul Revere's ride, or events relating to one's personal life, such as where two people first met, where your descendants came from, etc. Such historical or personal references can be assigned locations or related to a city or other general location with general GPS coordinates such that each entry can be given a location for access.

Such information can be given different access capabilities, e.g., some information entered can be given general public access, other information can require a password, and still other information can be only accessed by people that are given access ahead of time. Each access level can be selectively controlled by the person that enters the data.

For example, an entry regarding the Boston Massacre can have several levels of access; a generic description of “The Boston Massacre occurred here,” can have general public access. A more detailed description of the event, along with the aftermath and trial of the participants where John Adams was the defense attorney and obtained an acquittal for his British soldier clients, could require a password or a fee for a user to access. Still other information about a particular soldier or other person involved with the event or location may only be accessed by certain predetermined users. Each content “author” can determine a fee-based access and manage such access for each entry that author creates.

Components of the Present Invention

The present invention comprises several components, namely a context manager, contribution engine, locators, a location browser, a rating engine, link management, a route planner, clients, notifications, charge and payment management, content intellectual property management, a web crawler, a mapping engine, and databases for storing the information. Each component of the system 50 of the present invention is described herein below.

Context Manager 52

For any known location the present invention can provide contextual information about the place. For example, the present invention might tell the history, news, shopping, reviews, graffiti, and other information. This information can be professional—urban planning, for example—or can be highly personal—such as an individual's story of their own house.

Contribution Engine 54

Allows users to contribute stories to the system. Contributions will be organized into various databases depending upon the source. A user can “tell” the present invention anything about any location. This might include spoken word, text, audio, video, images, computer programs, or any other media that you wish. Users can “contextualize” places with their own stories and information.

Locators 56

Mechanisms allow users to identify their location. Locators range from interactive location descriptions (“I'm at the corner of Hollywood and Vine”) to automated location devices (e.g., GPS). The user can specify a common name (“the statue of Nicholas I in St. Petersburg”), a street intersection (“Main and 5^{th}”), a reference (“300 meters south of the petrol station in Bedfordshire”), a street address (“1234 Wilshire Blvd”), and The present invention will provide the correct map locations.

Location Browser 58

The location browser 58 is an interactive user interface to browse locations and the contextual information.

Rating Engine 60

The rating engine 60 is a mechanism that allows users to rate locations and provide feedback.

Link Management 62

Users can link locations with other locations. For example, a user telling the service about their ancestral history can link homesteads with wedding locations, birthplaces, and so forth to create a “tour” or collection of associated locations. An architect can link a site with antecedent influences and associated buildings. Linking also allows for vendors and other transitional events to have a chance for connecting with the present invention users. For example, a link between two points on a tour might require transportation—allowing transportation vendors a chance to sell their wares to the present invention users.

Route Planner 64

The present invention can guide the user (or follow his guidance) along known routes. For example, follow Lewis and Clark's trail from Virginia to Washington State with the service guiding at each point. Routes can be created by authors ranging from historical societies, theme parks, or commercial tour planners, to school classrooms.

Clients 66A, 66B

Clients are the means by which users interact with the system. Clients will include cell phones, desktop computers, tablet PCs, PDAs, and GPSs.

Notification(s)

These inform users of pertinent information in the context of his/her current location.

Charge and Payment Management 68

A full internal accounting system will track user charges and content provider credits for creation and viewing of content. Various charge, credit, and payment schemes will be available. For example, content providers will be able to choose to make their content free, impose a charge per access, set up subscription- or time-based services, or bundle access to different categories of content. Similarly, tools will allow Binary Protocol partners to bundle access to content “channels” under different charge plans, in a similar manner to cable TV or wireless telephone service plans. Basic plans include free, flat rate, flat rate/multiple tier, bundled with provider or access features, micro-payment (non-commercial user adds content, gets service credit for viewership), add-on subscription services (e.g. Fodor's), transaction-based (e.g. select concert venue, buy tickets).

Content Intellectual Property Management 70

Safeguard IP rights of content rights holders under terms they specify when the content is entered into the present invention.

Dorothy (Web Crawler or web-hot) 72

A web crawler 72 or web-bot that walks the Internet, examines pages for location information, and records location based indices to the web pages. Web sites, data, and databases can be indexed according to location, allowing, for example, a newspaper to report what it knows about any location within its area.

Databases 74

Multiple data repositories to store the location information.

Mapping Engine 76

A rendering engine capable of proving a cartographic view of the contextual location based information with standard location queues (e.g., roads, landmarks, country boundaries, state boundaries, etc.). The mapping engine provides for changes in proportional size (i.e., zoom in or out) and detail such that the user can examine the data with an appropriate view.

System Overview

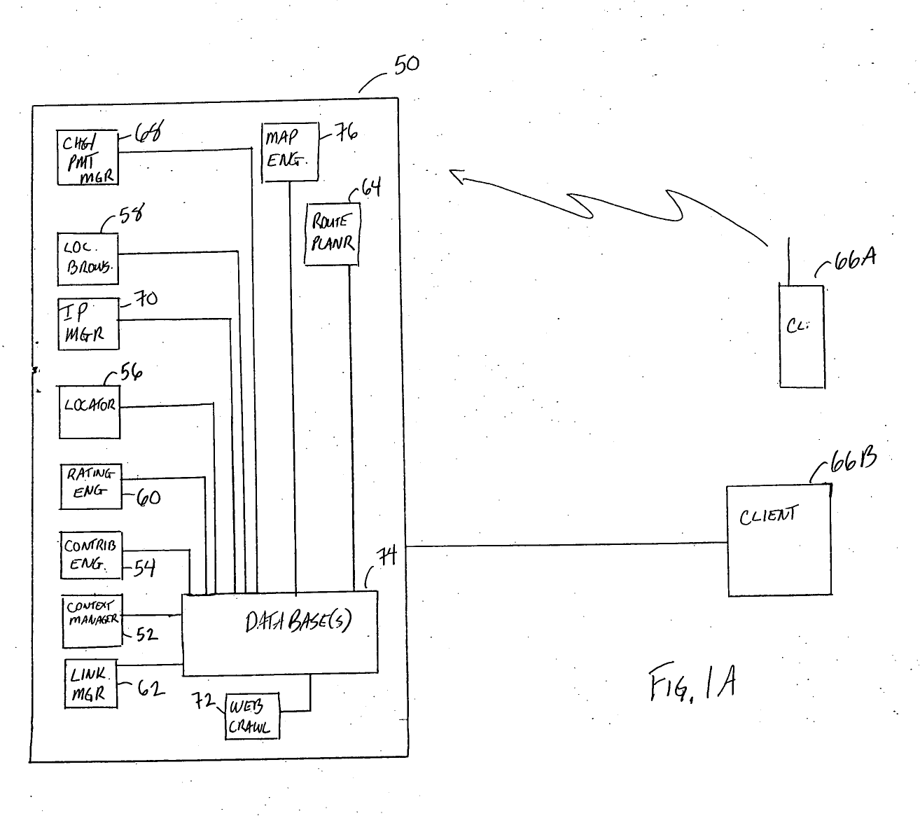

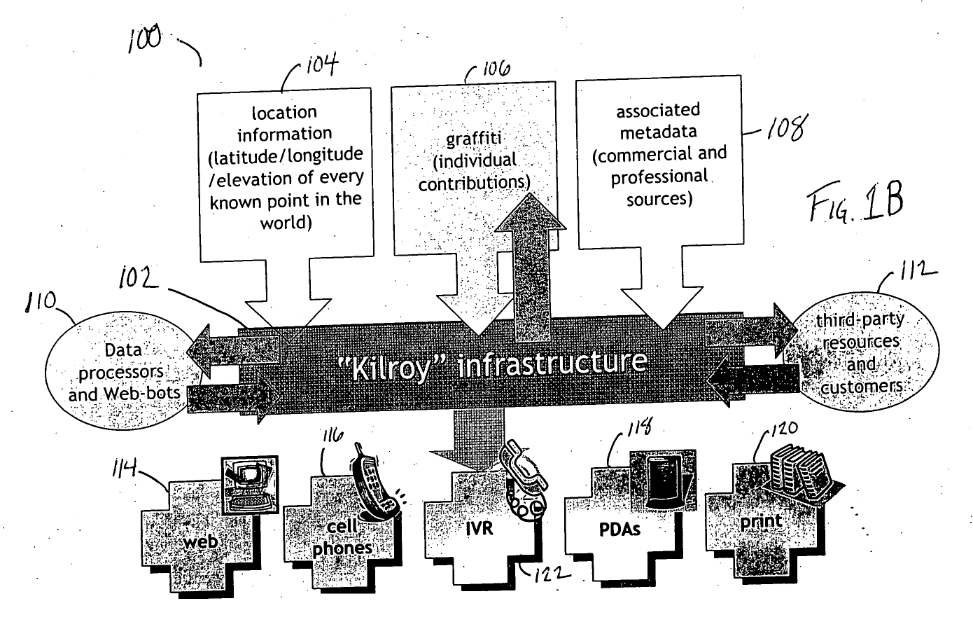

FIG. 1 illustrates a system overview of the present invention.

System 100 comprises an infrastructure 102 that couples location information 104, individual contributions (graffiti) 106, commercial and professional sources 108 of information, data processors and web-bots 110, and other resources and customers 112. These sources and retrieval points are usually accessed by or entered into system 100 via computers on the internet 114, cellular telephones 116, Personal Data Assistants (PDAs) 118, print media 120, and Interactive Voice Response (IVR) portals 122. System 100 can contain additional sources and/or access points without departing from the scope of the present invention.

The infrastructure 102 (also referred to as the “Kilroy” infrastructure herein) allows location information 104 to be associated with sources of data regarding specific locations that can be accessed via the infrastructure through the use of the Internet 114, cellular telephones 116, PDAs 118, or entered using individual contributions 106 or commercial or professional sources 108 through devices 114-118. Such access through system 100 includes the ability to enter individual contributions 106 before visiting a location, while at a location, or sometime afterward, as well as accessing such previously entered data whether entered by individual contribution (graffiti) 106 or professional or commercial sources (associated metadata) 108.

Because each source 106-108 data entry is associated with a given location data point 104, users 112 that plan to visit such a location can review the data either prior to their trip or while at or near the location. Users 112 can use the data processors and web-bots 110 to find the graffiti 106 or associated metadata 108 of interest through infrastructure 102, and can use the graffiti 106 and associated metadata 108 at any time and, when appropriate, rate such data for usefulness, content appropriateness, age appropriateness, or other items.

Further, infrastructure 102 allows for graffiti 106 and associated metadata 108 to be access controlled. For example, some graffiti 106 or associated metadata 108 may be private to a select group of people, or only accessible if a fee is paid prior to accessing the data. A third party resource 112, such as a credit card company or additional access data storage facility, may be required to perform such access control.

A typical example of the use of system 100 is illustrated through example. No limitation of the present invention is intended through the use of example herein. User 112 may be planning a trip to Washington, D.C., and want to visit Mount Vernon. The user 112 may use the Internet 114, either using a web browser or the system 100 will respond through a web-bot 110, which is a server side-process that automatically scans the Internet for information and cataloging the information by location, to find out if any graffiti 106 or associated metadata 108 has been entered for Mount Vernon. The user 112 may just enter “Mount Vernon” or a specific latitude and longitude into a search engine, and web-bot 110 can convert the common name to a latitude/longitude or vice versa.

The web-bot 110 would then report that several graffiti 106 contributions and several associated metadata 108 contributions have been made on Mount Vernon, and the user 112 would be presented a list of such items on the display of the user's 112 computer. Each display of the graffiti 106 items or associated metadata 108 items would likely show a title, a brief description, an access level required, and a cost for access, as follows:

| Title | Description | Access Level | Cost |
|---|---|---|---|
| Mount | Officially sanctioned | Fee Required, | 5.95 (can activate |
| Vernon | audio/visual walking | Public | 30 days in advance) |
| Walking | Tour of Mount Vernon | | |
| Tour | by the Mount Vernon | | |
| | Ladies Association | | |
| My Visit | Contributed by John | Public | Free |
| to Mount | Smith (audio only) | | |
| Vernon | | | |
| Mount | George and Martha's | Fee Required | 10.95 (can not in |
| Vernon | secretive history at | | advance) |
| Secrets | Mount Vernon | | |
| | (audio/visual) | | |
| Mount | George Washington's | Private | For George |
| Vernon | Diary of Mount | | Washington |
| Diary | Vernon (audio/visual/ | | University Students |
| | interactive) | | Only; password |
| | | | required |

The entry shown is for illustration only and is not intended to limit the scope of the present invention. Many Graphical User Interfaces (GUIs) are possible for displaying the possible information available, including but not limited to map views, other tabular views, and window-based GUI views.

The first entry is the professional contribution 108 from the Mount Vernon Ladies Association, and would be accessible to any user 112 that could pay the 5.95 fee. For users that wanted to purchase this item, the item could be activated in advance, so that a user 112 could review the information prior to the trip, as well as use the information while visiting Mount Vernon. The description can indicate the type of material that is contained in the data, e.g., audio/visual data is included, so a PDA 118 may be a better access device than a cellular telephone 116 if the user 112 has access to such a device.

The second entry is graffiti 108 entered by an individual. There is no fee, and it is an audio only entry.

The third entry is a commercial entry 108 from a private party, who will not allow any previous viewing of the data. This can be accomplished by using a time stamp, and the data can only be viewed once, or by using a location sensitive access stamp. The location sensitive access stamp would only allow those users within a certain radius of Mount Vernon, as determined by the position of access reported by the computer on the internet 114, cellular telephone 116, or PDA 118, to access this particular commercial data source 108. As with entry one, a fee is required, which can be relayed to the private party via a third party resource 112, namely, a credit card company that debits the user's 112 credit card and credits the private party account for the amount stated.

The fourth entry is a private graffiti 106 entry that can only be accessed using a password. It is intended for a specific audience, in this case, a university class, who may be required to perform a field study at Mount Vernon. The system 100 can ensure that each student user 112 logs into the system by recording the accesses made to this entry and reporting such entries to the third-party resource 112, namely, the professor's record book. The listing is also interactive, and can require inputs from the student, which can be time and/or location tagged, as well as require substantive input, to ensure that each student performed the task. As an illustration of such an interactive entry, the student user 112 may be asked to answer a question such as “What color was the dining room of Mount Vernon?” to which, the student user 112 would answer, “green” (the substantive input) and send that input, which may or may not be location and/or time tagged to show that the student user 112 was actually at Mount Vernon at a specific time. Such an answer would be sent to a third party resource 112 or a data processor 110, such that the system 100 could record the answer or, if desired, grade the student's answer.

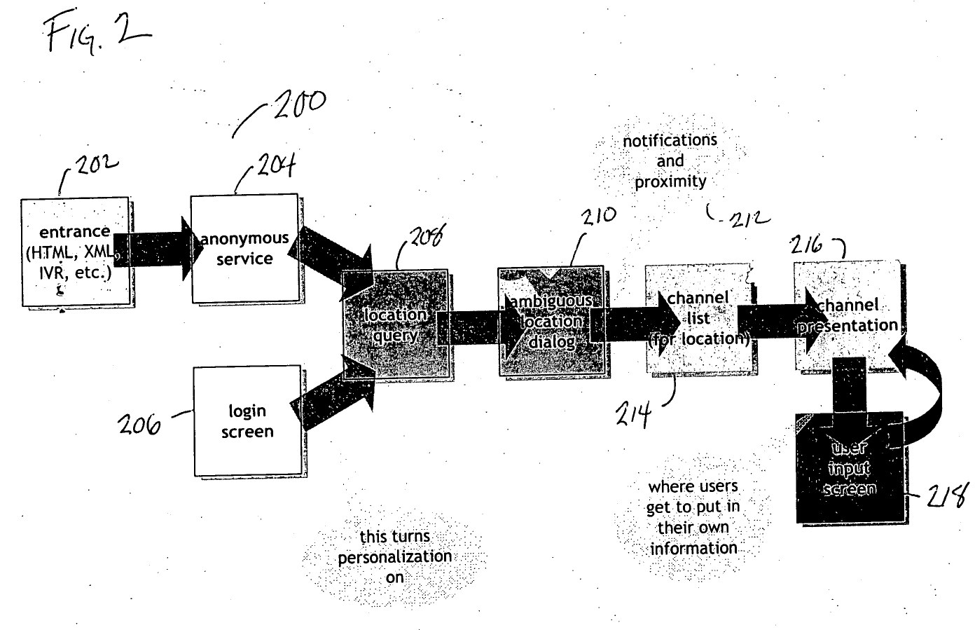

FIG. 2 illustrates a first flow diagram in accordance with the present invention.

Flow 200 illustrates the flow of information in the infrastructure 102 described with respect to FIG. 1. Entrance 202 is a portal that allows any user 112 to access the database of information. Anonymous service 204 is shown to illustrate that anyone can be a guest user to the infrastructure 102 for queries to view the data available.

A login screen 206 is also provided to allow registration of users 112 for access to the information within the infrastructure. Instead of having a pay-per-use service, some graffiti 106 providers or commercial providers 108 may decide on a monthly fee or annual fee schedule for access to the graffiti 106 or associated metadata 108 from such sources, which would require the use of a login screen 206 for such users. Further, login screen 206 indicates to system 100, and infrastructure 102, any personalization of the system 100 that a particular user 112 has provided to the system at a previous time. Such personalization would include favorite locations, preferred data sources, access levels, etc. System 100 can also suggest other data items of interest that previous users 112 have enjoyed, e.g., people that enjoyed visiting Mount Vernon also enjoyed visiting George Washington's Gristmill, Monticello, etc.

Further, logging in to the system 100 allows users to optionally provide their location to the system, either manually or via automatic reporting devices such as GPS devices, so that the system 100 can acquire knowledge about the user and/or the user's location preferences. A user that lives in one area, e.g., Minneapolis, Minn., but travels often to Los Angeles, Calif., may want to be able to inform system 100 that they are currently in Los Angeles, such that system 100 can provide information pertinent to the user's location. Further, the system 100 can also optionally review a user's calendar (e.g., Microsoft Outlook) to see where a user will be in the future, such that system 100 can suggest items of interest to the user for future use.

From either the anonymous service 204 or login screen 206, a location query 208, e.g., “Mount Vernon” or “latitude 37.15 North, 118.25 West” is entered. For those entries that may give ambiguous results, a dialog box 210 is provided to garner more information from user 112 to provide the most pertinent data. For example, if a user entered “New York” as a location, the system may ask for a further description, such as “New York (New York City?) New York (New York State?)” and ask the user to choose from the selections provided. This could be an iterative process because there may be more than one ambiguity that needs to be resolved.

A location can be specified in alternative ways, either automatically or manually. For example, a user 112 can perform a search using a common place or street name, idiomatic or local slang name, from a map grid, from a textual search, or use a hierarchical browser technique. Further, the system 100 can automatically search using GPS data from the user 112, an IP or cellular telephone Cell ID address, a telephone number or area code, a Time Difference Of Arrival (TDOA) triangulation location, “hotspot” or popular places on the system 100, or other automatic location specifications can be displayed. Further, a predictive location or configurable location selection display can be used, for example, when user 112 is in a car, the system 100 can predict where user 112 will be because system 100 can monitor the car's direction, speed, and location, and determine which road user 112 is on to predict user 112's arrival at a location five miles down the road. The system 100 can also pre-emptively download data to a device such that the data is accessible at a future time when user 112 is in a new location.

If the user 112 is a registered user 112, then notifications and proximity to specific locations reporting 212 can be enabled to occur when the user 112 is geographically proximate to a preferred location or is within a certain amount of time of arrival to a preferred location.

Once the location is properly determined in block 210, a channel list 214 for each location is provided. The channel list 214 shows the potential data services provided as sorted by either a preferred grouping, e.g., by commercial source 108 or graffiti 106, or by some other grouping such as historical facts or interesting people that have been at that location. Each channel listing 214 can also have access limitations if desired. Once the listing of channels 214 is presented, the user 112 selects a channel for a listing of individual selections or entries on that channel in box 216. Such a box is illustrated above in the example for Mount Vernon.

Once at this channel presentation listing 216, registered or unregistered users 112 can enter their own information on a user input screen 218. This is one of the selections presented on the channel presentation listing 216, and can be access controlled by registration or other means if desired within system 100. The user input screen can accept audio, visual, interactive, or other data inputs as desired.

Further, the user input screen allows users to rate the value and other attributes of the content for each entered graffiti 106 or associated metadata 108 entry. A star rating (one on a scale of five stars) or other rating system can be used if desired.

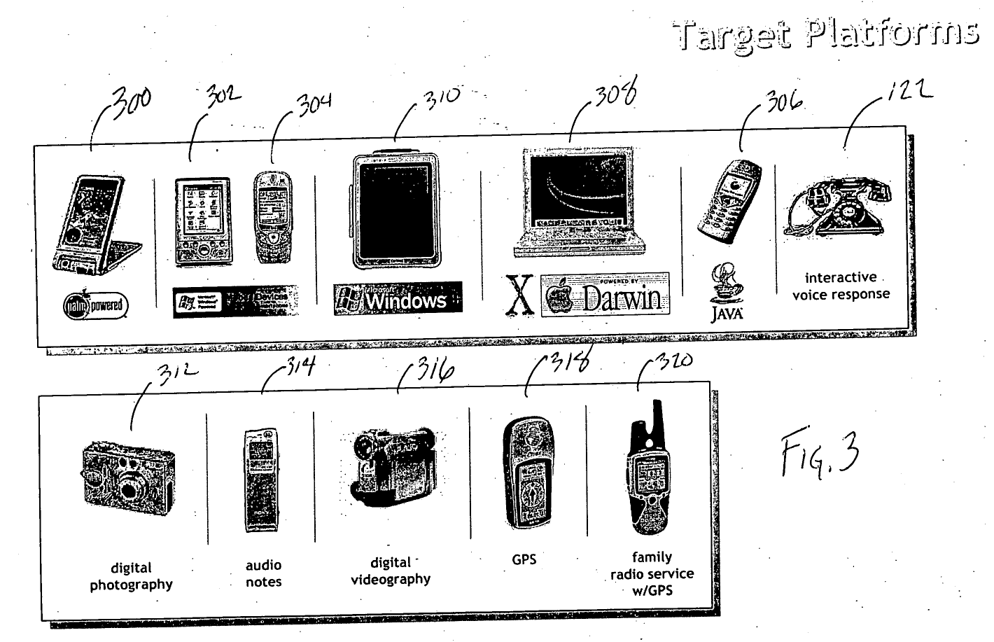

FIG. 3 illustrates typical platforms compatible or used with the present invention.

As described with respect to FIG. 1, Palm™ 300 powered or Windows™ 302 powered PDAs 118, cellular 304 and java 306 cellular telephoned 116, Apple™ 308 or Windows™ 310 internet capable computers 114, IVR 122, or other devices, such as digital cameras 312, audio tape recorders 314, digital video cameras 316, handheld GPS devices 318, and Family Radio Service (FRS) devices that are GPS enabled 320 can access the system 100. Other devices that have wired or wireless capabilities can also use system 100 without departing from the scope of the present invention.

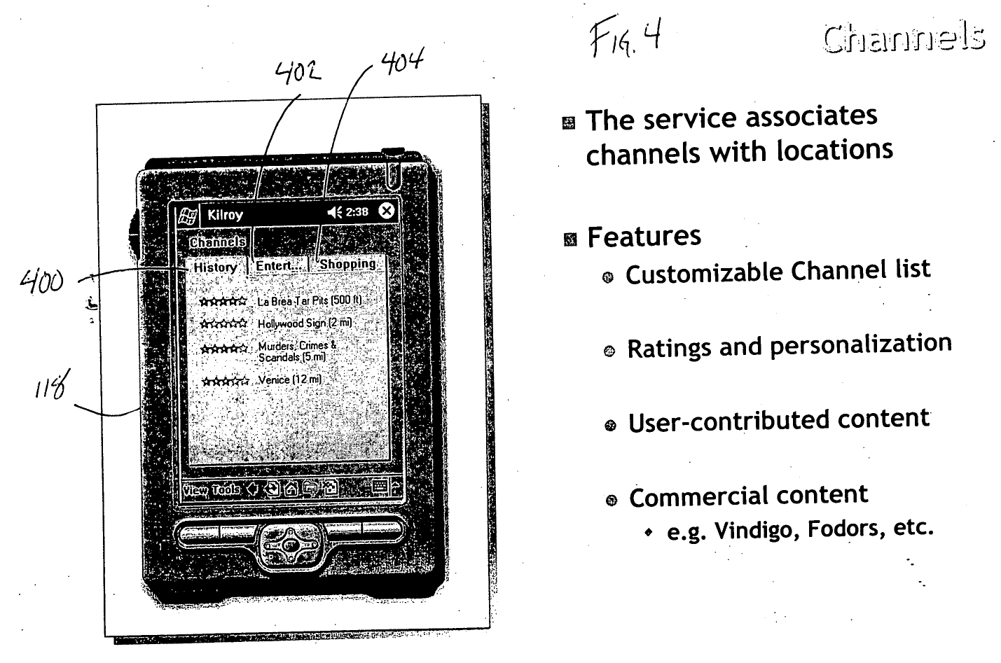

FIG. 4 illustrates a preferred embodiment of the channels and user interface of the present invention.

PDA 118 shows channels 400-404 listed for a given area, namely, Los Angeles, Calif. Channel 400 is a history related channel, whereas channel 402 is an entertainment channel, and channel 404 is a shopping related channel. The channels 400-404 can be arranged by subject or by location as desired.

On channel 400, several places are listed, each rated using a user 112 rating system of stars and a distance from the user's 112 present location. For example, the La Brea Tar Pits is only 500 feet from the user's present location, but Venice is 12 miles from the present location. Each of the channels 400-404 has several locations in this example. However, channels 400-404 can have sub-channels or other means of producing a list of entries for a given location, such as the La Brea Tar Pits, that would present to the user 112 a choice of items to select.

Each item in the list has several attributes, e.g., a read-only or read-write attribute, a description, etc. Some data entries, e.g., a commercial source 108, may want to protect the content by not allowing users 112 to access the data entered; other entries may desire further user 112 input to catalog additional data as more users 112 note additional features associated with a given location. Each entry can be rated by a user 112, similar to the rating formulas used by eBay and Amazon for their product lines and service providers.

Flowchart

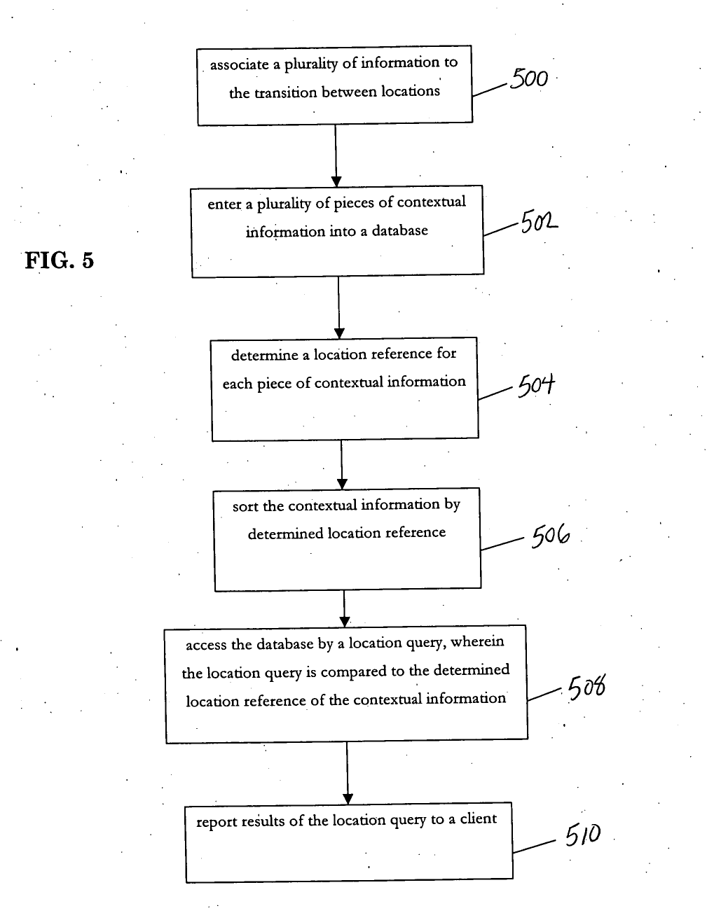

FIG. 5 is a flowchart of the steps used in practicing the invention.

Block 500 illustrates associating a plurality of information to the transition between locations.

Block 502 illustrates entering a plurality of pieces of contextual information into a database.

Block 504 illustrates determining a location reference for each piece of contextual information.

Block 506 illustrates sorting the contextual information by determined location reference.

Block 508 illustrates accessing the database by a location query, wherein the location query is compared to the determined location reference of the contextual information.

Block 510 illustrates reporting results of the location query to a client

Conclusion

In conclusion, the present invention discloses a method and apparatuses for providing contextual location-based information. An apparatus in accordance with the present invention comprises a computer-based infrastructure, including at least one database for storing information on at least one location, a context manager, coupled to the database, for indexing and sorting the information stored in the database, a contribution engine, coupled to the database, for entering, storing, managing, and retrieving additional information in the database, a locator, coupled to the contribution engine and the database, for converting a plurality of references to a specific location to a common location designation, and a location browser, coupled to the database, for retrieving and reviewing information in the database; and at least one client, which communicates with the infrastructure, for entering, editing, and retrieving information from the database.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description.

1. A contextual location-based service apparatus, comprising:
a) a computer-based infrastructure, comprising:
1) at least one database for storing information on at least one location;
2) a context manager, coupled to the database, for indexing and sorting the information stored in the database;
3) a contribution engine, coupled to the database, for entering, storing, managing, and retrieving additional information in the database;
4) a locator, coupled to the contribution engine and the database, for converting a plurality of references to a specific location to a common location designation;
5) a location browser, coupled to the database, for retrieving and reviewing information in the database; and
b) at least one client, which communicates with the infrastructure, for entering, editing, and retrieving information from the database.

2. The contextual location-based service apparatus of claim 1, further comprising a link manager, coupled to the database, for linking a plurality of locations within the database to each other.

3. The contextual location based service apparatus of claim 2, further comprising a rating engine, coupled to the database, for rating information stored in the database.

4. The contextual location based service apparatus of claim 3, further comprising—a charge and payment manager, coupled to the database, for controlling access to information in the database and for collecting fees from a user of a client for accessing the controlled access information in the database.

5. The contextual location based service apparatus of claim 4, further comprising a mapping engine, coupled to the database, for providing to the client a visual output of information, thematic information, and metadata-stored in the database.

6. The contextual location based service apparatus of claim 5, further comprising a route planner, coupled to the link manager and the database, for accessing information stored in the database in sequence as the client travels between the plurality of locations.

7. The contextual location based service apparatus of claim 6, further comprising an Intellectual Property manager, coupled to the database and the charge and payment manager, for providing proper access to intellectual property stored in the database.

8. A method for providing contextual location-based information, comprising:
associating a plurality of information to the transition between locations;
entering a plurality of pieces of contextual information into a database;
determining a location reference for each piece of contextual information;
sorting the contextual information by determined location reference;
accessing the database by a location query, wherein the location query is compared to the determined location reference of the contextual information; and
reporting results of the location query to a client.

9. The method of claim 8, further comprising:
entering a fee amount for accessing a specific piece of contextual information; and
charging the fee amount to a user before, during, or after the specific piece of contextual information is accessed.

10. The method of claim 9, further comprising linking at least two determined location references to each other.

11. The method of claim 10, further comprising entering a rating associated with the contextual information for evaluating the contextual information entered in the database.

12. The method of claim 11, further comprising a storing visual data as at least a portion of the contextual information entered in the database, for providing to the client a visual output of information stored in the database.

13. The method of claim 12, further comprising linking a plurality of pieces of contextual information in the database, for accessing the pieces of contextual information stored in the database in sequence.

14. The method of claim 13, further comprising controlling access to intellectual property entered as contextual pieces of information stored in the database.

15. A contextual location services system, comprising:
a database for storing contextual information on a plurality of geographic locations, and
a client, which communicates with the database, for retrieving the stored contextual information, comprising a mobile communications device, wherein the client retrieves information based on geographic location and is able to select one or more pieces of contextual information for presentation on the client, wherein presentation on the client includes audio presentation, video presentation, and audio/visual presentation, and the contextual information includes at least location information and at least one other piece of information about the geographic location.
